(19) United States
(12) Patent Application Publication
(10) Pub. No.: US 2025/0326243 A1
(43) Pub. Date: Oct. 23, 2025

(54) Upcycling Device for Used Papers

(71) Applicant: Ousmane Cinna Ba, Silver Spring, MD (US)

(72) Inventor: Ousmane Cinna Ba, Silver Spring, MD (US)

(21) Appl. No.: 19/187,736

(22) Filed: Apr. 23, 2025

Related U.S. Application Data
(60) Provisional application No. 63/637,677, filed on Apr. 23, 2024.

(51) Int. Cl. B41M 7/00; B23K 26/06; B23K 26/402

(52) U.S. Cl. CPC B41M 7/0009; B23K 26/0643; B23K 26/402

(57) ABSTRACT

The used-paper upcycling device is intended to provide users with an ink-removal device for used papers. More specifically, an objective of the used-paper upcycling device is to convert used paper into clean plain paper again, so that it may be reused for writing, printing, scanning, etc. To accomplish this, the device comprises a main body integrated with multiple trays and an ink-removing system for efficient upcycling of used paper. The device further includes a control system, and a paper-transferring system that helps with carrying the used papers through the ink-removing system and delivering clean papers. Further, the device includes multiple electric and electronic components integrated within the main body for enabling smooth operation of the device. Thus, the used-paper upcycling device enables users to conserve paper, reduce waste, and reuse used paper.

### FIELD OF THE INVENTION

The present invention relates generally to an upcycling device for used papers. More specifically, the present invention is a device that enables users to erase writing from used papers and so as to reuse the same papers for future uses such as printing, writing, etc.

### BACKGROUND OF THE INVENTION

More than 200 million trees are cut down daily to make paper. This means that a tree is cut down every 2.5 seconds. Recycling paper prevents waste and also conserves resources and energy used when making paper from scratch. In other words, when paper gets reused/recycled it preserves natural resources, saves energy, reduces greenhouse gas emissions and keeps landfill space free from other types of waste that can't be recycled. Most of the paper used in offices, hospitals, universities, etc. are shredded away or thrown in the garbage. Thus, it is the need of the hour to reuse paper as much as possible, so that we prolong the lifecycle of the materials and reduce the carbon footprint of the manufacturing process.

It is an objective of the present invention to convert used paper to clean white paper again, so that it may be reused again for writing, printing, scanning, etc. To accomplish this, the present invention comprises an ink-removing system for efficient upcycling of used paper. Further, the present invention comprises a compact device with multiple chambers and trays that can intake used paper with ink or writing on it, and output clean ink-removed paper. Thus, the present invention enables users to conserve paper, reduce waste, and reuse used paper in a user-friendly and cost-efficient manner.

### SUMMARY OF INVENTION

The present invention is intended to provide users with an ink-removal device for used paper. More specifically, it is an objective of the present invention to convert used paper into clean plain paper again, so that it may be reused for writing, printing, scanning, etc. To accomplish this, the present invention comprises a main body integrated with multiple trays and an ink-removing system for efficient upcycling of used paper. The present invention further comprises a control system, and a paper-transferring system that helps with carrying the used papers through the ink-removing system and delivering clean papers. Further, the present invention comprises multiple electric and electronic components integrated within the main body for enabling smooth operation of the device. Thus, the present invention enables users to conserve paper, reduce waste, and reuse used paper.

### BRIEF DESCRIPTION OF THE DRAWINGS

FIG. 1 is a schematic view showing the electronic and the electrical components of the present invention, wherein the electronic connections between components are shown in thicker lines, and wherein the electrical connections between components are shown in thinner lines.

FIG. 2 is a top-front-right perspective view of the present invention.

FIG. 3 is a top-front-right perspective view, wherein an output paper receptacle is in an open configuration, and a plurality of used paper as well as ink-removed paper are retained in the paper-input tray and output-paper receptacle.

FIG. 4 is a top-front-left perspective view of the present invention, wherein the output paper receptacle is open.

FIG. 5 is a front elevational view of the present invention.

FIG. 6 is a schematic view of the interior of an ink-erasing chamber, according to a preferred embodiment of the present invention.

### DETAILED DESCRIPTION OF THE INVENTION

All illustrations of the drawings are for the purpose of describing selected versions of the present invention and are not intended to limit the scope of the present invention.

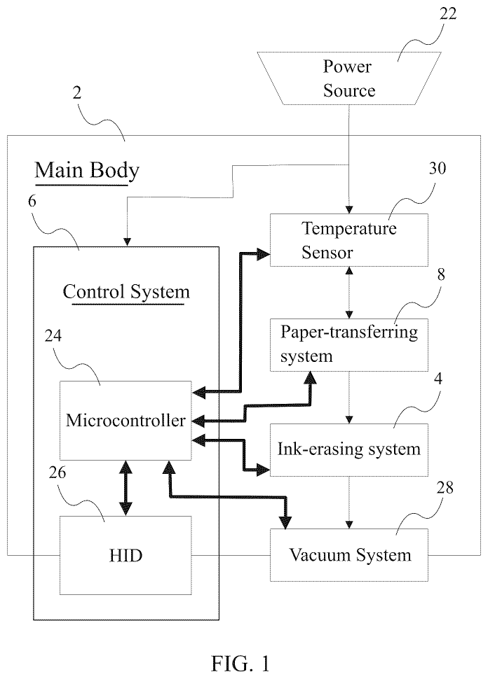

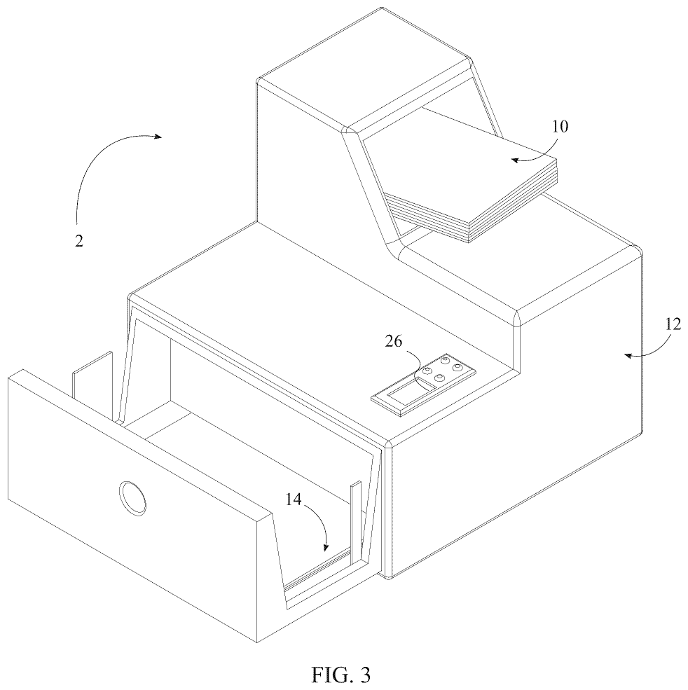

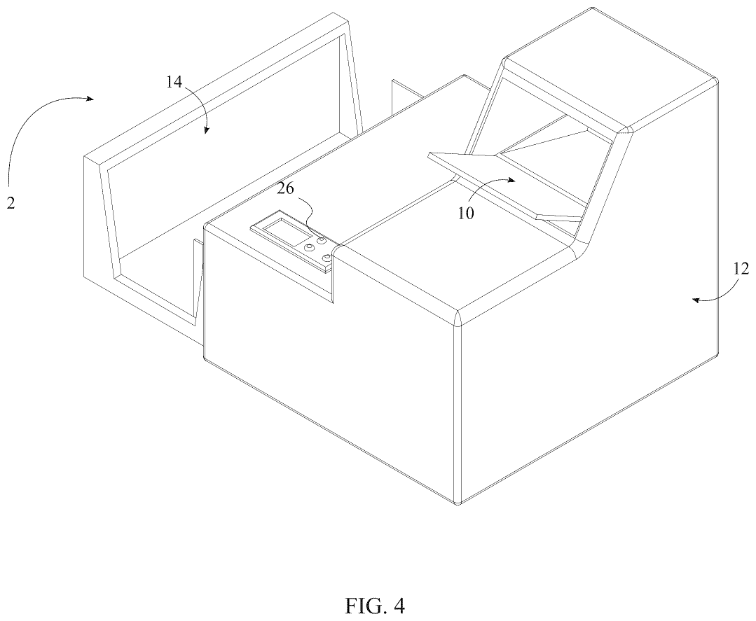

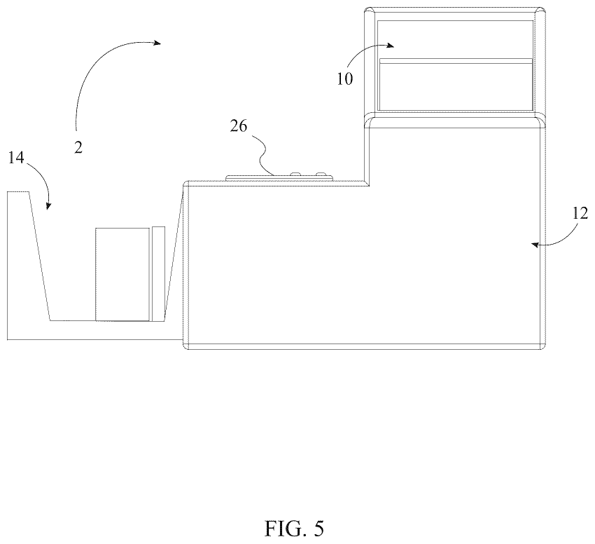

The present invention is a used-paper upcycling device that is used to convert used paper into clean plain paper again, so that it may be reused for writing, printing, scanning, etc. The following description is in reference to FIG. 1 through FIG. 6.

According to a preferred embodiment, the present invention comprises a main body 2, an ink-erasing system 4, a control system 6, and a paper-transferring system 8. The main body 2 is the primary casing that holds the important mechanical components and all the other necessary electric/electronic circuitry of the present invention. Preferably, the main body 2 is made of a sturdy material such as hard plastic, stainless steel etc. However, the main body 2 may comprise any size, shape, material, components, arrangement of components, etc. that are known to one of ordinary skill in the art, as long as the objectives of the present invention are fulfilled.

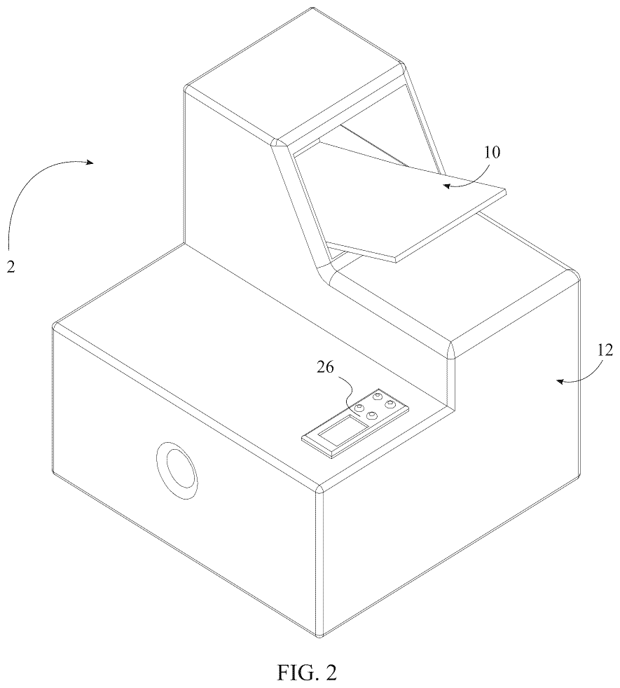

As seen in FIG. 1 through FIG. 5, the main body 2 comprises a paper input tray 10, an ink-erasing chamber 12, and a paper output receptacle. Preferably, the paper input tray 10 is positioned on an upper end of the main body 2, wherein users can easily load the used papers. Similarly, the paper output receptacle 14 is a chamber positioned towards a bottom end of the main body 2, wherein cleaned out paper that can be reused is received and stacked one over the other. The paper input tray 10 and the paper output receptacle 14 may comprise cubical trays, bins, or receptacles that are made of a sturdy material such as hard plastic, vinyl, etc. and have dimensions big enough to house a stack of A4 size sheet papers. As seen in FIG. 1 and FIG. 2, the paper output receptable is a retractable box-tray, that may be opened and closed as needed. However, the paper input tray 10 and the paper output receptacle 14 may comprise any other shape, size, material, dimensions, etc., as long as the objectives of the present invention are not altered. In the preferred embodiment, the ink-erasing chamber 12 is positioned between the paper input tray 10 and the paper output receptacle. This is so that used-paper from the paper input tray 10 may be passed onto the ink-erasing chamber 12 to be cleaned of any ink and later transferred into the paper output receptacle 14 in a smooth manner.

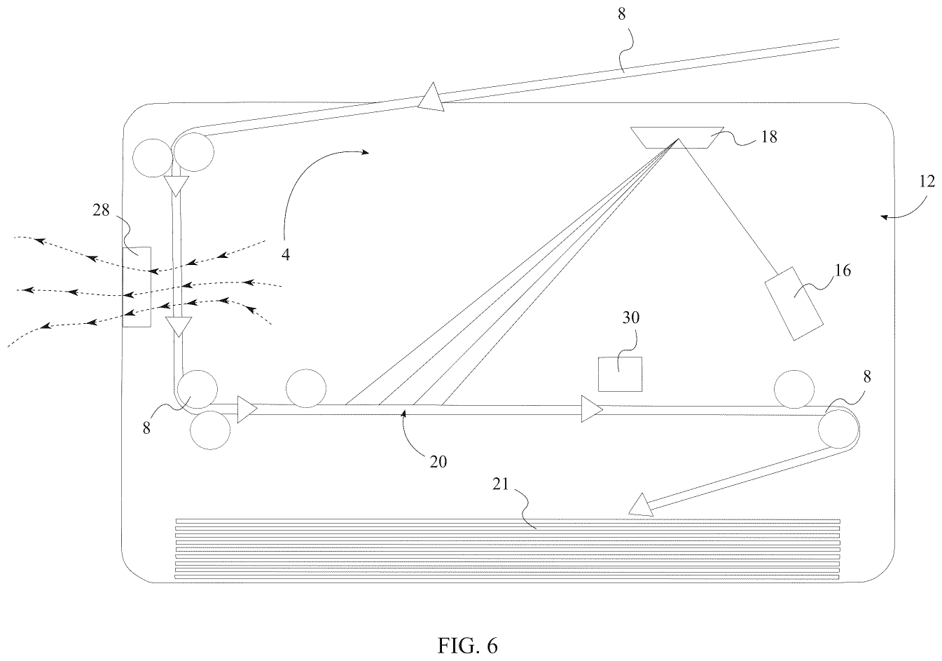

The ink-erasing system 4 is a combination of components that work together to remove the ink from the used paper. As seen in FIG. 6, the ink-erasing system 4 is positioned within the ink-erasing chamber 12. In the preferred embodiment, the ink-erasing system 4 is a laser ink-removing system. However, the ink-erasing system 4 may comprise any other components, arrangement of components etc. that are known to one of ordinary skill in the art, as long as the intents of the present invention are not altered.

The control system 6 is the electrical and electronic system of the present invention, or the brain of the device, that controls the operation of the various components of the present invention. Preferably, the control system 6 and the paper-transferring system 8 are mounted within the main body 2. Further, the paper-transferring system 8 enables transfer of paper along the various points of the invention. In the preferred embodiment, the paper-transferring system 8 is a conveyor belt. More specifically, the paper-transferring system 8 is operatively coupled in between the paper input tray 10 and the paper output receptacle 14, wherein the paper-transferring system 8 is used to transfer paper from the paper-transferring system 8, through the ink-erasing chamber 12, and to the paper output receptacle 14.

As discussed, the ink-erasing system 4 helps remove the ink from used paper that is travelling from the paper input tray 10 through the paper-transferring system 8. In other words, the ink-erasing system 4 is operatively coupled to the paper-transferring system 8, wherein the ink-erasing system 4 is used to remove ink from used piece of paper that is being moved through the ink-erasing chamber 12 by the paper-transferring system 8. To enable smooth functioning of the above-mentioned systems, the paper-transferring system 8 and the ink-erasing system 4 are electronically connected to the control system 6.

A more detailed description of the present invention follows. According to the preferred embodiment, the ink-erasing system 4 further comprises a laser source 16 and a reflective surface 18. A laser source 16 along with the reflective source may be used as a specialized spotter, and it may be used to remove pigments of ink, dye, etc. The laser source 16 may comprise any pulse energy, brand, technology of emission, etc. as long as the intents of the present invention are not altered. Further, in the preferred embodiment, the reflective surface 18 is a mirror. However, any other reflective source may be used, that does not hinder the functioning of the present invention. Preferably, the laser source 16 is mounted adjacent to the paper-transferring system 8, and the reflective surface 18 is mounted adjacent to an interior wall of the ink-erasing chamber 12, as seen in FIG. 6. This is so that a controlled laser beam may be incident on the paper where ink is present, and the writing ink may be removed with the correct amount of laser pulse energy falling on the correct spot on the paper. To that end, the reflective surface 18 is oriented towards the paper-transferring system 8, and the laser source 16 is oriented towards the reflective surface 18. Furthermore, the paper-transferring system 8 comprises a laser target area 20, wherein the laser target area 20 is positioned within the ink-erasing chamber 12, and the laser source 16 is in optical communication with the laser target area 20 by the reflective surface 18. Thus, the combination of the laser source 16, and the reflective surface 18, emits the right amount of laser energy on to the laser target area 20, that is determined and controlled with the help of the control system 6, to remove ink from used paper and transform it into ink-free usable paper 21. It should be noted that any other ink-erasing system 4 that is known to one of ordinary skill in the art may be used, as long as the objectives of the present invention are fulfilled.

In order to provide electrical power to the components of the present invention, the present invention comprises a power source 22. Accordingly, the control system 6, the paper-transferring system 8, and the ink-erasing system 4 are electrically connected to the power source 22. Preferably, the power source 22 is a rechargeable battery. However, any other source of power, or a combination of the following sources may be employed for the smooth functioning of the present invention. Examples of such power sources 22 include, but are not limited to, Li ion batteries, magnetic power converters, solar power converters, etc. Furthermore, the present invention may comprise an electrical terminal that allows the present invention to receive electrical power from an external power supply, and/or an electrical terminal that allows the present invention to send electrical power to an external electrical load. Additionally, the power source 22 may be connected to the one of more pushbutton switches, that enables them to temporarily shut off and restore the power to the components of the device.

Continuing with the preferred embodiment, the control system 6 comprises a microcontroller 24 and a human interface device (HID) 26. Preferably, the microcontroller 24 is mounted within the main body 2, and the HID 26 is integrated into an external surface of the main body 2. The microcontroller 24 is a processing device that interprets commands received from the HID 26 and uses these commands to manage the operation of the electrical components within the present invention. Further, the microcontroller 24 may comprise a wireless communication module, that connects and communicates with external devices via wireless data transmission protocols. Example standards of what the wireless communication module is capable of using includes, but are not limited to, Bluetooth, WI-FI, GSM, CDMA, ZigBee, etc. The HID 26 forms the platform for user interaction in order to perform the various operations of the present invention. In the preferred embodiment, the HID 26 comprises at least one switch, or one or more push button switches wherein the one of more pushbutton switches are positioned adjacent to a front panel of the main body 2. Further, the HID 26 may perform various operations, including, but are not limited to, turning the device power on/off, turning on/off an ink-removing process, start/stop paper input/output, and perform various other operations based on the capacities and modules on the microcontroller 24. To accomplish this, the microcontroller 24 is electronically connected to the HID 26, the ink-erasing system 4, and the paper-transferring system 8.

Continuing with the preferred embodiment, the present invention comprises a vacuum system 28, wherein the vacuum system 28 is in fluid communication with the ink-erasing chamber 12. The vacuum system 28 is used to remove potentially harmful particles from the air inside the ink-erasing chamber 12, thereby enabling a smooth operation of the present invention. To that end, the vacuum system 28 is mounted adjacent to the ink-erasing chamber 12 within the main body 2, and the vacuum system 28 is electronically connected to the control system 6. Preferably, the vacuum system 28 comprises a HEPA filter and other motors and sensors that vacuum pulls particles out of the ink-erasing chamber 12. However, the vacuum system 28 may comprise any other components, arrangement of components, etc. that are known to one of ordinary skill in the art, as long as the intents of the present invention are not altered.

Continuing with the preferred embodiment, the present invention comprises a temperature sensor 30, wherein the temperature sensor 30 is in thermal communication with the ink-erasing chamber 12. The temperature sensor 30 is used to continuously monitor the temperature of the system and shuts down the system in case of excess heat. To that end, the temperature sensor 30 is electronically connected to the control system 6. Thus, together with all the above-described components and features, the used-paper upcycling device enables users to conserve paper, reduce waste, and reuse used paper.

Although the invention has been explained in relation to its preferred embodiment, it is to be understood that many other possible modifications and variations can be made without departing from the spirit and scope of the invention as hereinafter claimed.

What is claimed is:

1. A used-paper upcycling device comprising:
a main body;
an ink-erasing system;
a control system;
a paper-transferring system;
the main body comprising a paper input tray, an ink-erasing chamber, and a paper output receptacle;
the ink-erasing chamber being positioned between the paper input tray and the paper output receptacle;
the ink-erasing system being positioned within the ink-erasing chamber;
the control system and the paper-transferring system being mounted within the main body;
the paper-transferring system being operatively coupled in between the paper input tray and the paper output receptacle, wherein the paper-transferring system is used to transfer paper from the paper-transferring system, through the ink-erasing chamber, and to the paper output receptacle;
the ink-erasing system being operatively coupled to the paper-transferring system, wherein the ink-erasing system is used to remove ink from used piece of piece being moved through the ink-erasing chamber by the paper-transferring system; and
the paper-transferring system and the ink-erasing system being electronically connected to the control system.

2. The used-paper upcycling device of claim 1 further comprising:
the ink-erasing system comprising a laser source and a reflective surface;
the paper-transferring system further comprising a laser target area;
the laser source being mounted adjacent to the paper-transferring system;
the reflective surface being mounted adjacent to an interior wall of the ink-erasing chamber;
the reflective surface being oriented towards the paper-transferring system;
the laser source being oriented towards the reflective surface;
the laser target area being positioned within the ink-erasing chamber; and
the laser source being in optical communication with the laser target area by the reflective surface.

3. The used-paper upcycling device of claim 2, wherein the reflective surface is a mirror.

4. The used-paper upcycling device of claim 1 comprising:
a power source; and
the control system, the paper-transferring system, and the ink-erasing system being electrically connected to the power source.

5. The used-paper upcycling device of claim 1 further comprising:
the control system comprising a microcontroller and a human interface device (HID);
the microcontroller being mounted within the main body;
the HID being integrated into an external surface of the main body; and
the microcontroller being electronically connected to the HID, the ink-erasing system, and the paper transferring system.

6. The used-paper upcycling device of claim 5, wherein the HID is at least one switch.

7. The used-paper upcycling device of claim 1 comprising:
a vacuum system;
the vacuum system being in fluid communication with the ink-erasing chamber;
the vacuum system being mounted adjacent to the ink-erasing chamber within the main body; and
the vacuum system being electronically connected to the control system.

8. The used-paper upcycling device of claim 1 further comprising:
a temperature sensor;
the temperature sensor being in thermal communication with the ink-erasing chamber; and
the temperature sensor being electronically connected to the control system.

9. The used-paper upcycling device of claim 1, wherein the paper-transferring system is a conveyor belt.

10. The used-paper upcycling device of claim 1, wherein the paper output receptable is a retractable box-tray.

11. A used-paper upcycling device comprising:
a main body;
an ink-erasing system;
a control system;
a paper-transferring system;
the main body comprising a paper input tray, an ink-erasing chamber, and a paper output receptacle;
the ink-erasing system comprising a laser source and a reflective surface;
the paper-transferring system further comprising a laser target area;
the ink-erasing chamber being positioned between the paper input tray and the paper output receptacle;
the ink-erasing system being positioned within the ink-erasing chamber;
the control system and the paper-transferring system being mounted within the main body;
the paper-transferring system being operatively coupled in between the paper input tray and the paper output receptacle, wherein the paper-transferring system is used to transfer paper from the paper-transferring system, through the ink-erasing chamber, and to the paper output receptacle;
the ink-erasing system being operatively coupled to the paper-transferring system, wherein the ink-erasing system is used to remove ink from used piece of piece being moved through the ink-erasing chamber by the paper-transferring system;
the paper-transferring system and the ink-erasing system being electronically connected to the control system;
the laser source being mounted adjacent to the paper-transferring system;
the reflective surface being mounted adjacent to an interior wall of the ink-erasing chamber;
the reflective surface being oriented towards the paper-transferring system;
the laser source being oriented towards the reflective surface;
the laser target area being positioned within the ink-erasing chamber; and
the laser source being in optical communication with the laser target area by the reflective surface.

12. The used-paper upcycling device of claim 11, wherein the reflective surface is a mirror.

13. The used-paper upcycling device of claim 11 comprising:
a power source; and
the control system, the paper-transferring system, and the ink-erasing system being electrically connected to the power source.

14. The used-paper upcycling device of claim 11 further comprising:
the control system comprising a microcontroller and a human interface device (HID);
the microcontroller being mounted within the main body;
the HID being integrated into an external surface of the main body; and
the microcontroller being electronically connected to the HID, the ink-erasing system, and the paper transferring system.

15. The used-paper upcycling device of claim 14, wherein the HID is at least one switch.

16. The used-paper upcycling device of claim 11 comprising:
a vacuum system;
the vacuum system being in fluid communication with the ink-erasing chamber;
the vacuum system being mounted adjacent to the ink-erasing chamber within the main body; and
the vacuum system being electronically connected to the control system.

17. The used-paper upcycling device of claim 11 further comprising:
a temperature sensor;
the temperature sensor being in thermal communication with the ink-erasing chamber; and
the temperature sensor being electronically connected to the control system.

18. The used-paper upcycling device of claim 11, wherein the paper-transferring system is a conveyor belt.
